(19) United States
(12) Patent Application Publication
(10) Pub. No.: US 2003/0147042 A1
(43) Pub. Date: Aug. 7, 2003

(54) Polarizing element and liquid crystal display

(76) Inventors: Ikuo Kawamoto, Ibaraki-shi (JP); Naoki Takahashi, Ibaraki-shi (JP); Tadayuki Kameyama, Ibaraki-shi (JP)

Correspondence Address: ARMSTRONG,WESTERMAN & HATTORI, LLP, 1725 K STREET, NW, SUITE 1000, WASHINGTON, DC, 20006, US

(21) Appl. No.: 10/072,455

(22) Filed: Feb. 7, 2002

(51) Int. Cl. G02F 1/1335

(52) U.S. Cl. 349/194

(57) ABSTRACT

A polarizing element for a liquid crystal display is disclosed having high brightness, and less coloration when viewed squarely or obliquely in a wide viewing angle range. The polarizing element is produced by providing a light-diffusion pressure-sensitive adhesive layer onto a reflective polarizing plate that separates incident natural light into reflected light and transmitted light both of which are composed of polarized light.

### BACKGROUND OF THE INVENTION

1. Field of the invention

The present invention relates to a polarizing element for a liquid crystal display.

2. Description of the related art

Conventional liquid crystal displays comprise reflective polarizing plates for obtaining high brightness. Such a reflective polarizing plate is either a linearly-polarized light separation plate or a circularly-polarized light separation plate that is positioned on a sidelight-type light-guide plate composing a backlight so as to separate incident natural light into reflected light and transmitted light both of which are composed of polarized light. In this liquid crystal display, light emitted from the light-guide plate is polarized by the reflective polarizing plate and fed to a polarizing plate in order to suppress absorption loss at the polarizing plate and improve the brightness. However, considerable coloration is observed when viewed from slant angles, and the color will change to yellow or blue depending on the viewing angles.

### SUMMARY OF THE INVENTION

The present invention provides a polarizing element for a liquid crystal display having high brightness, where coloration is suppressed when viewed squarely or obliquely in a wide viewing angle range.

For this purpose, embodiments of the present invention provide a polarizing element comprising a light-diffusion pressure-sensitive adhesive layer on a reflective polarizing plate that separates incident natural light into reflected light and transmitted light both of which are composed of polarized light Embodiments of the present invention also provide a liquid crystal display comprising the polarizing element

The light-diffusion pressure-sensitive adhesive layer provided to the polarizing plate can diffuse transmitted light and mix various colored light beams so as to suppress coloration, and thus, in some aspects, the present invention provides a liquid crystal display having excellent brightness and display quality in a wide viewing angle range including a frontal viewing angle and slant viewing angles.

In some embodiments, the reflective polarizing plate is selected from a linearly-polarized light separation plate, a circularly-polarized light separation plate, and a combination of a circularly-polarized light separation plate and a retardation plate.

The circularly-polarized light separation plate can comprise a cholesteric liquid crystal layer. The cholesteric liquid crystal layer can be obtained as a liquid crystal polymer layer that is Granjean-oriented on a transparent polymer substrate via an orientation film. The cholesteric liquid crystal layer can have a superimposed structure of plural cholesteric liquid crystal layers different from each other in the helical pitch of the Granjean orientation. The thus obtained circularly-polarized light separation plate can reflect circularly polarized light in a wide wavelength range including a visible light range.

When a circularly-polarized light separation plate is used, preferably, circularly polarized light that has passed the circularly-polarized light separation plate is polarized linearly by means of a retardation plate before entering another polarizing plate, so that an absorption loss can be suppressed. Circularly polarized light can be converted into linearly polarized light effectively by using a quarter wavelength plate for the retardation plate.

In some embodiments, the light-diffusion pressure-sensitive adhesive layer is prepared by including uncolored transparent particles in a polymer. When the polymer is an acrylic polymer having a weight average molecular weight of at least 100,000, the thus obtained polarizing element has excellent optical transparency, weather resistance, heat resistance or the like and is also resistant to embossing or peeling under influences of heat and humidity. The uncolored transparent particles can be inorganic/organic particles. The average particle diameter is preferably in a range from 0.5 μm to 20 μm from a viewpoint of the optical diffusivity.

Furthermore, the light-diffusion pressure-sensitive adhesive layer of the polarizing element according to the present invention is interposed between the circularly-polarized light separation plate and the retardation plate, so that the brightness can be improved and the coloring can be decreased.

### BRIEF DESCRIPTION OF THE DRAWINGS

FIG. 1 is a cross-sectional view showing a polarizing element in accordance with one embodiment of the present invention.

### DETAILED DESCRIPTION OF THE INVENTION

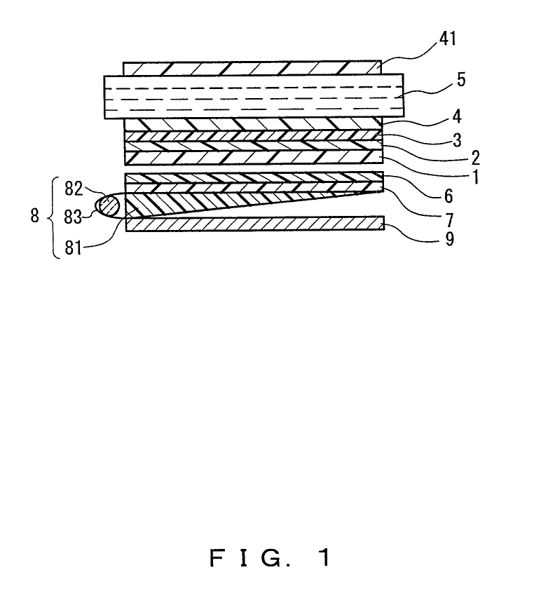

A polarizing element in accordance with one embodiment of the present invention is provided by attaching a light ion pressure-sensitive adhesive layer onto a reflective polarizing plate that separates incident natural light into reflected light and transmitted light both of which are composed of polarized light. FIG. 1 shows an example of such a polarizing plate. Numeral 2 in FIG. 1 denotes a light-diffusion pressure-sensitive adhesive layer. A reflective polarizing plate as shown in FIG. 1 is prepared by attaching a quarter plate 3 onto a circularly-polarized light separation plate 1 (reflective polarizing plate). The polarizing element shown in FIG. 1 is assembled to provide a liquid crystal display, where 4 and 41 denote polarizing plates, 5 denotes a liquid crystal cell and 8 denotes a light source.

The reflective polarizing plate can be selected suitably as long as it can separate incident natural light into reflected light and transmit light both of which are composed of polarized light Accordingly, brightness can be improved by obtaining transmitted light of predetermined polarization by emitting light from a light source such as a backlight The transmitted light is fed not to be substantially absorbed in the polarizing plate. As a result, the quantity of light available for the liquid crystal display can be increased to improve brightness.

When the light reflected at the reflective polarizing plate is reversed via a reflecting layer or the like so as to re-enter the reflective polarizing plate, the reflected light can pass partly or wholly as light of a predetermined polarization. By using the reflected light, light passing the reflective polarizing plate can be increased to further improve the brightness of the liquid crystal display and the like.

A suitable reflective polarizing plate can be selected from a linearly-polarized light separation plate (e.g., “D-BEF” supplied by 3M Co.) that transmits linearly polarized light having a predetermined polarization axis while reflecting other light, such as a multilayered thin film of a dielectric substance or a multilayered laminate of thin films with varied refraction aeolotropy, and a circularly-polarized light separation plate such as a cholesteric liquid crystal layer that reflects either clockwise or counterclockwise circularly polarized light while transmitting other light

For a linearly-polarized light separation plate, the transmitted light enters the polarizing plate by matching the polarization axis so that absorption loss due to the polarizing plate is controlled and the light can be transmitted efficiently. For a circularly-polarized light separation plate, preferably, the circularly polarized light is converted to linearly polarized light before entering the polarizing plate in an aspect of controlling of the absorption loss, though the circularly polarized light can enter the polarizing plate directly. Circularly polarized light can be converted to linearly polarized light efficiently by using a quarter wavelength plate for the retardation plate.

There is no specific limitation on the cholesteric liquid crystal layer composing the circularly-polarized light separation plate. For example, it can be provided as a liquid crystal polymer layer that is Granjean-oriented via an orientation film formed by treating (e.g., rubbing) on a surface of a liquid crystal polymer film or a transparent substrate (e.g., PCF 350 supplied by Nitto Denko Corporation and ‘Transmax’ supplied by Merck and Co., Inc.). The circularly-polarized light separation plate can have a superimposed structure of two or more layers provided by combining cholesteric liquid crystal layers different from each other in the helical pitch (and thus, different in the reflection wavelength) of Granjean orientation.

Due to the above-mentioned superimposing, the thus obtained circularly-polarized light separation plate reflects circularly polarized light in a wide wavelength range including a visible light range, and this can provide transmitted circularly polarized light having a wide wavelength range. The superimposed cholesteric liquid crystal layers can be formed by a repeated coating or the like. At that time, the layers are preferably superimposed so that the helical pitch of the Granjean orientation follows an order of the size, for the purpose of improving the light efficiency, and furthermore, improving the brightness. In such a case, the retardation plates are preferably located on the layers at the side with a smaller helical pitch so as to decrease coloration caused by a slant viewing or the like.

In general, the transparent substrate is formed from a polymer though there is no specific limitation. The polymer is, for example, cellulose-based polymers such as cellulose diacetate and cellulose triacetate; polyester-based polymers such as polyethylene terephthalate and polyethylene naphthalate; polycarbonate-based polymers; acrylic polymers such as polymethyl methacrylate; styrene-based polymers such as polystyrene and acrylonitrile-styrene copolymer; olefin-based polymers such as polyethylene, polypropylene, polyolefin having a cyclo- or norbornene structure, and ethylene-propylene copolymer; vinyl chloride-based polymers; and amide-based polymers such as nylon and aromatic polyamide.

Alternatively, polymers for forming the transparent substrate can be based on imide, sulfone, polyethersulfone, polyether ether ketone, polyphenylene sulfide, vinyl alcohol, vinylidene chloride, vinyl butyral, allylate, polyoxymethylene, or epoxy; any blends of the polymers. Furthermore, the transparent substrate can be formed from polymers that will be cured by heat or irradiation of ultraviolet rays etc., such as polyester-based polymer, acrylic polymer, urethane-based polymer, amide-based polymer, silicone-based polymer and epoxy-based polymer. A particularly preferred example of transparent substrates with excellent isotropism is a cellulose-based polymer film.

A retardation plate (especially, a quarter wavelength plate) located with the circularly-polarized light separation plate is selected from a birefringent film comprising stretch film etc. of various polymers, an orientation film of a discotic/nematic liquid crystal polymer, and a layer of the oriented liquid crystal polymer supported on a transparent substrate.

A retardation plate functioning as a quarter wavelength plate in a wide wavelength range such as a visible light range can be obtained by superimposing a retardation layer functioning as a quarter wavelength plate for monochromatic light (e.g., light having a wavelength of 550 nm) and a separate retardation layer presenting different phase contrast property (e.g., a retardation layer functioning as a half wavelength plate). Therefore, a retardation plate arranged with the reflective polarizing plate can comprise one or plural retardation layer(s).

A polymer for forming the birefringent film can be selected from the polymers as materials for the above-mentioned transparent substrate. Particularly preferred examples with an excellent crystallization property include polyester-based polymer and polyether ether ketone. The stretch film can be prepared by uniaxial stretch, biaxial stretch and the like, or it can have a refractive index controlled in the film thickness direction by applying shrinkage force and/or stretch force while adhering to a heat shrinkable film

Embodiments of the present invention provides a light-diffusion pressure-sensitive adhesive layer that mixes various colored light beams so as to decrease coloration caused by a slant viewing. Accordingly, the light-diffusion pressure-sensitive adhesive layer can be provided to at least one side of a reflective polarizing plate. In a case of combining a circularly-polarized light separation plate with a retardation plate, the light-diffusion pressure-sensitive adhesive layer can be arranged outside the retardation plate. However, in an aspect of improving brightness and decreasing coloration, preferably, the light-diffusion pressure-sensitive adhesive layer is interposed between a circularly-polarized light separation plate and a retardation plate so as to integrally laminate the circularly-polarized light separation plate and the retardation plate via the light-diffusion pressure-sensitive adhesive layer. Since this method does not require any additional adhesive layers, thin plates can be provided.

A light-diffusion pressure-sensitive adhesive layer can be formed by, for example, adding uncolored transparent particles to a pressure-sensitive adhesive layer. The pressure-sensitive adhesive layer can be formed from a pressure-sensitive adhesive material. The pressure-sensitive adhesive material can be a pressure-sensitive adhesive or the like comprising a base polymer such as acrylic polymer, silicone-based polymer, polyester-based polymer, polyurethane-based polymer, polyether-based polymer, and synthetic rubber. An acrylic pressure-sensitive adhesive is particularly preferred since it can provide a polarizing element that is excellent in optical transparency, weather resistance, heat resistance or the like and also resistant to embossing or peeling under influences of heat and humidity.

An example of the acrylic pressure-sensitive adhesive is based on an acrylic polymer having a glass transition temperature of 0° C. or lower and a weight average molecular weight of at least 100,000. The polymer is produced by a copolymerization of an aLkyl ester of (meth)acrylic acid having an alkyl group with at most 20 carbon atoms (e.g., a methyl group, an ethyl group and a butyl group), and an acrylic monomer (modified substance) such as (meth)acrylic acid and hydroxyethyl (meth)acrylate, though this example is not limitative.

The uncolored transparent particles range from 0.5 μm to 20 μm in average particle diameter, and the examples include inorganic particles (that can be electroconductive) comprising silica, alumina, titania, zirconia, stannic oxide, indium oxide, cadmium oxide, and antimony oxide; and organic particles comprising crosslinked/uncrosslinked polymers or the like. These polymers can be used alone or as a combination of at least two kinds of polymers. Amount of the uncolored transparent particles dispersed in a light diffusion pressure-sensitive adhesive layer can be determined appropriately depending on some factors such as light diffusvity and adhesion force. Typically, the light-diffusion pressure-sensitive adhesive layer has a thickness ranging from 5 μm to 300 μm.

There is no specific limitation on a method of forming the light ion pressure-sensitive adhesive layer. For example, a mixture of a pressure-sensitive adhesive material and uncolored transparent particles can be provided to either a reflective polarizing plate or the retardation plate by e.g., rolling such as a calender roll method, and coating such as a doctor-blade method and a gravure roll coater method. Alternatively, the light diffusion pressure-sensitive adhesive layer can be formed on a separator according to any of the above-described methods and then transferred to a reflective polarizing plate or the like. The pressure-sensitive adhesive layer can be formed as superimposed layers of various pressure-sensitive adhesives, for example, by providing a layer containing no transparent particles on at least one surface of a layer containing transparent particles.

A polarizing element can be provided with one or plural suitable optical layer(s) such as a compensating retardation plate or a polarizing plate 4 as shown in FIG. 1, if necessary. The polarizing plate is provided for obtaining linearly polarized light used in liquid crystal displays or the like, while the compensating retardation plate is provided for compensating phase contrast caused by birefringence of a liquid crystal cell so as to improve the display quality.

There is no specific limitation on the polarizing plates, but any plates can be used as long as they transmit linearly polarized light having a certain polarization axis while absorbing the remaining light. Generally, a polarizing film can be used alone or it can be protected on at least one surface with a transparent protective layer. Examples of the polarizing film include a hydrophilic polymer film that is stretched after an adsorption of iodine and/or dichroic dyestuff; and polyene orientation films such as dehydrated polyvinyl alcohol and polyvinyl chloride that has been treated to remove hydrochloric acid. Examples of the hydrophilic polymer film include a polyvinyl alcohol-based film, a partially-formalized polyvinyl alcohol-based film, and a partially-saponified film based on ethylene-vinyl acetate copolymer.

The transparent protective layer that will be provided if necessary to at least one surface of the polarizing film can be formed from polymers described as materials of the transparent substrate. A particularly preferred transparent protective layer comprises polymers having excellent properties such as transparency, mechanical strength thermal stability and moisture-blocking property. The transparent protective layer can be formed by any suitable methods such as coating of a polymer solution and adhesion-lamination of films.

There is no specific limitation on the compensating retardation plate as long as it has proper phase contrast, but a birefringent film, oriented liquid crystal film or the like can be used as in the case of the above-mentioned retardation plate. Two or more retardation layers can be laminated for controlling optical properties such as the phase contrast Usually, a retardation plate for compensation is located between a polarizing plate and a liquid crystal cell.

Here, the polarizing plate and the compensating retardation plate can be simply overlaid. However, it is more preferable that the plates are integrally Laminated via an adhesive layer such as a pressure-sensitive adhesive layer in order to prevent shift of the optical axis for quality stabilization or to improve efficiency in assembling a liquid crystal display. The adhesive layer can be a light-diffusion pressure-sensitive adhesive layer. A polarizing element can comprise two or more light-diffusion pressure-sensitive adhesive layers. A pressure-sensitive adhesive layer can be provided, if necessary, to the outer surface of the polarizing element so as to adhere with other elements such as a liquid crystal cell. In case the pressure-sensitive adhesive layer is exposed to the surface, the surface can be covered with a separator or the like for antifouling before use.

A polarizing element of the present invention can be applied to various uses according to conventional techniques. It is preferred especially in forming a liquid crystal display to improve brightness and the like. The liquid crystal display can be produced by arranging a polarizing element as shown in FIG. 1. That is, a reflective polarizing plate (circularly-polarized light separation plate 1) is attached to one surface of a liquid crystal cell 5 via a polarizing plate 4, a retardation plate 3 and light-diffusion pressure-sensitive adhesive layer 2, while a polarizing plate 41 is located on the opposite surface of the liquid crystal cell 5. The polarizing element is located on a surface light source 8 (backlight) so that the circularly-polarized light separation plate 1 faces the surface light source 8. In FIG. 1, the polarizing element as a liquid crystal display unit is located on the surface light source 8 via a light-diffusion sheet 7 and a focusing sheet 6.

In the embodiment shown, the surface light source 8 is a sidelight-type light source. It has a light source 82 enveloped with a holder 83 and attached to a side of a light-guide plate 81 having a bottom surface provided with a reflecting layer 9. The focusing sheet 6 placed on the surface light source 8 comprises a prism sheet In this liquid crystal display, light emitted from the surface light source 8 is diffused at the light-diffusion sheet 7, controlled at the focusing sheet 6 in order to have a certain optical path and to enter a circularly-polarized light separation plate 1 of the polarizing element The light is separated into reflected light and transmitted light both of which are polarized light, and the transmitted circularly polarized light is diffused via the light-diffusion pressure-sensitive adhesive layer 2 and enters the retardation plate 3, linearly polarized at the retardation plate 3 and passes the polarizing plate 4 in a condition with less absorption loss. The light enters the liquid crystal cell 5 and thus, display light is emitted via the polarizing plate 41 at the visible side.

Accordingly, absorption loss at the polarizing plate 4 can be reduced. Furthermore, light reflected at the circularly-polarized light separation plate 1 is reversed at the reflecting layer 9 located on a lower surface of the light-guide plate, re-enters and passes the circularly-polarized light separation plate 1, and thus, it improves efficiency of the light As a result, brightness of the liquid crystal display can be improved.

Liquid crystal cells for liquid crystal displays can be selected arbitrarily. The examples include an active matrix driving type represented by a thin film transistor, a simple matrix driving type represented by a TNT type and a STN type, and a liquid crystal cell attached with a color filter. Suitable liquid crystal cells can be used for producing various liquid crystal displays.

In a process of producing a liquid crystal display, one or plural kinds of appropriate elements such as the polarizing plate 41, the light-diffusion sheet 7, the focusing sheet 6 (e.g., a prism sheet or a lens sheet), and the backlight 8 can be arranged suitably, and other optical sheets such as the compensating retardation plate can be arranged as well.

The above-mentioned polarizing plate 41 arranged at the visible side can be selected from the materials for the above-mentioned polarizing plates and it can be provided with additional layers such as an antiglare layer or an antireflection layer as required on the surface of the visible side. The antiglare layer scatters outdoor daylight reflecting on the surface. The antireflection layer suppresses surface reflection of outdoor daylight Thereby, these layers prevent surface-reflected light (glare) from hindering visibility of light passing through the display device. Therefore, the antiglare layer and the antireflection layer can be provided together to further improve the effect of preventing the surface-reflected light from hindering the visibility.

There is no specific limitation on the antiglare layer and the antireflection layer as long as the layers have the above-described functions. Similar to a case of the light-diffusion layer, the antiglare layer can be formed by providing fine irregularity for diffusing and reflecting light Such a reflecting layer having fine irregularity can be provided by any of suitable methods such as deposition, plating and coating, ie., vacuum deposition, ion plating, sputtering, and a sol-gel method. One example is an interference film comprising, for example, a multilayered coating film of inorganic oxides of various refractive indices, and a coating film of a low-refractive material such as a fluorine-based compound.

The present invention will be illustrated further in detail with reference to the following Examples.

### EXAMPLE 1

A cholesteric liquid crystal polymer was superimpose-coated and oriented on a cellulose triacetate film 40 min thickness via a rubbing orientation film. The thus obtained cholesteric liquid crystal polymer layer had a four-layer-structure where the respective layers have reflection central wavelength of 760 nm, 650 nm, 550 nm and 430 nm. On the fourth layer with a reflection central wavelength of 430 nm, a quarter wavelength plate was adhered via an acrylic light-diffusion pressure-sensitive adhesive layer (A). The acrylic light-diffusion pressure-sensitive adhesive layer (A) was 25 μm in thickness and it contained silicone uncolored transparent particles having an average particle diameter of 4.0 μm. On the quarter wavelength plate, a polarizing plate was adhered and laminated via an acrylic pressure-sensitive adhesive layer (B) having no fine particles, and an acrylic pressure-sensitive adhesive layer (C) was further provided to the outside, and thus, a polarizing element was obtained.

### EXAMPLE 2

A polarizing element was obtained in the same manner as Example 1 except that the light-diffusion pressure-sensitive adhesive layer (A) was substituted by an acrylic pressure-sensitive adhesive layer containing no transparent particles.

### EXAMPLE 3

A polarizing element was obtained in the same manner as Example 1 except that the light ion pressure-sensitive adhesive layer (A) and the internal pressure-sensitive adhesive layer (B) containing no fine particles were exchanged to each other.

### EXAMPLE 4

A polarizing element was obtained in the same manner as Example 1 except that the light-diffusion pressure-sensitive adhesive layer (A) and the external pressure-sensitive adhesive layer (C) containing no fine particles were exchanged to each other.

### EXAMPLE 5

A polarizing element was obtained in the same manner as Example 1 except that the internal pressure-sensitive adhesive layer (B) was substituted by a light-diffusion pressure sensitive adhesive layer.

### EXAMPLE 6

A polarizing element was obtained in the same manner as Example 1 except that the external pressure-sensitive adhesive layer (C) was substituted by a light-diffusion pressure sensitive adhesive layer.

### EXAMPLE 7

A polarizing element was obtained in the same manner as Example 1 except that the layer (A) was substituted by a pressure-sensitive adhesive layer containing no fine particles, while the layers (B) and (C) were substituted by light-diffusion pressure-sensitive adhesive layers containing fine particles.

### EXAMPLE 8

A polarizing element was obtained in the same manner as Example 1 except that all of the three layers were light-diffusion pressure-sensitive adhesive layers containing fine particles.

### Evaluation

Each of the polarizing elements obtained in Examples 1-8 was arranged by interposing a cholesteric liquid crystal layer on a backlight comprising a sidelight-type light-guide plate provided with a reflecting layer at the bottom in order to examine the brightness by means of a brightness photometer (BM7 supplied by TOPCON CORP.) and also to examine color variation in the slant viewing direction (variation in colors). The results are shown in Table 1. Each brightness value was calculated as a rate to a brightness value (100) obtained without using a reflective polarizing plate.

TABLE 1

| | Layers¹⁾ | | | Brightness | Color |
|---|---|---|---|---|---|
| Examples | Layer (A) | Layer (B) | Layer (C) | rate | variation²⁾ |
| 1 | Yes | No | No | 1.38 | A |
| 2 | No | No | No | 1.40 | C |
| 3 | No | Yes | No | 1.35 | B |
| 4 | No | No | Yes | 1.34 | B |
| 5 | Yes | Yes | No | 1.28 | B |
| 6 | Yes | No | Yes | 1.27 | B |
| 7 | No | Yes | Yes | 1.27 | B |
| 8 | Yes | Yes | Yes | 1.22 | B |

¹⁾Yes: a light-diffusion pressure-sensitive adhesive layer containing fine particles
No: a pressure-sensitive adhesive layer containing no fine particles
²⁾(A): no variation in colors
(B): some variation in colors
(C): considerable variation in colors

The invention may be embodied in other forms without departing from the spirit or essential characteristics thereof. The embodiments disclosed in his application are to be considered in all respects as illustrative and not limiting. The scope of the invention is indicated by the appended claims rather than by the foregoing description, all changes that come within the meaning and range of equivalency of the claims are intended to be embraced therein.

What is claimed is:

1. A polarizing element comprising a reflective polarizing plate for separating incident natural light into reflected light and transmitted light both of which are composed of polarized light, and a light-diffusion pressure-sensitive adhesive layer provided to the reflective polarizing plate.

2. The polarizing element according to claim 1, wherein the reflective polarizing plate is selected from the group consisting of a linearly-polarized light separation plate, a circularly-polarized light separation plate, and a combination of a circularly-polarized light separation plate and a retardation plate.

3. The polarizing element according to claim 2, wherein the circularly-polarized light separation plate comprises a cholesteric liquid crystal layer.

4. The polarizing element according to claim 3, wherein the cholesteric liquid crystal layer is a liquid crystal polymer layer that is Granjean-oriented on a transparent polymer substrate via an orientation film.

5. The polarizing element according to claim 4, wherein the cholesteric liquid crystal layer has a superimposed structure of cholesteric liquid crystal layers different from each other in a helical pitch of the Granjean orientation.

6. The polarizing element according to claim 2, wherein the retardation plate is a quarter wavelength plate.

7. The polarizing element according to claim 2, wherein the light-diffusion pressure-sensitive adhesive layer is interposed between the circularly-polarized light separation plate and the retardation plate.

8. The polarizing element according to claim 1, wherein the light-diffusion pressure-sensitive adhesive layer is made of a polymer containing uncolored transparent particles.

9. The polarizing element according to claim 8, wherein the polymer is an acrylic polymer having a weight average molecular weight of at least 100,000.

10. The polarizing element according to claim 8, wherein the uncolored transparent particles having an average particle diameter ranging from 0.5 μm to 20 μm are selected from inorganic particles and organic particles.

11. The polarizing element according to claim 1, wherein the light-diffusion pressure-sensitive adhesive layer is provided adjacent to the reflective polarizing plate.

12. A liquid crystal display having a polarizing element comprising a reflective polarizing plate for separating incident natural light into reflected light and transmitted light both of which are composed of polarized light, and also a light-diffusion pressure-sensitive adhesive layer provided to the reflective polarizing plate.

13. A method of manufacturing a polarizing element, wherein the polarizing element comprises a reflective polarizing plate for separating incident natural light into reflected light and transmitted light both of which are composed of polarized light, and a light-diffusion pressure-sensitive adhesive layer provided to the reflective polarizing plate.

14. The method according to claim 13, wherein the light-diffusion pressure-sensitive adhesive layer is provided adjacent to the reflective polarizing plate.

15. The method according to claim 13, wherein the reflective polarizing plate is selected from the group consisting of a linearly-polarized light separation plate, a circularly-polarized light separation plate, and a combination of a circularly-polarized light separation plate and a retardation plate.

16. The method according to claim 13, wherein the light-diffusion pressure-sensitive adhesive layer is made of a polymer containing uncolored transparent particles.

17. The method according to claim 16, wherein the polymer is an acrylic polymer having a weight average molecular weight of at least 100,000.

18. The method according to claim 16, wherein the uncolored transparent particles having an average particle diameter ranging from 0.5 μm to 20 μm are selected from inorganic particles and organic particles.
